(19) United States
(12) Patent Application Publication
(10) Pub. No.: US 2010/0071859 A1
(43) Pub. Date: Mar. 25, 2010

(54) Device With a Shutter Which May Be Wound Around a Drum

(75) Inventor: Benoit Coenraets, Bruxelles (BE)

Correspondence Address: BAKER & DANIELS LLP, 300 NORTH MERIDIAN STREET, SUITE 2700, INDIANAPOLIS, IN, 46204, US

(73) Assignee: Dynaco International S.A., Moorsel (BE)

(21) Appl. No.: 12/525,790

(22) PCT Filed: Feb. 4, 2008
(86) PCT No.: PCT/EP2008/051350

§ 371 Date: Aug. 4, 2009

(30) Foreign Application Priority Data
Feb. 7, 2007 (EP) 07101921.0

(51) Int. Cl. E06B 9/174; E06B 9/58

(52) U.S. Cl. 160/313; 160/309

(57) ABSTRACT

The invention relate to a flexible shutter device, designed for closing a bay (6), cooperating with drive means which permit the movement of the flexible shutter (1) between an open position and a closed position. The device comprises a drum (8) which may turn about the horizontal axis (11) thereof and about which the shutter is wound in the open position forming a roll of turns of successive layers of the shutter attaching one to the other and from which the flexible shutter can be unrolled and pushed into the closed position thereof. Suspension means for the drum comprise a suspension axis (13) parallel to the axis of rotation of the drum about which the rotational axis of the drum can oscillate. Contact elements (16, 36) exert a driving force on the roll essentially radial with relation to the drum. The distance of the axis of rotation (11) of the drum from the reference plane formed by the unwound flexible shutter in the closed position thereof is always less than the distance of the suspension axis (13) from said reference plane, whatever the position of the shutter.

### FIELD OF THE INVENTION

The invention relates to a flexible shutter device intended for closing a window or any type of opening, cooperating with driving means for moving the flexible shutter between an open position and a closed position. The invention relates more particularly to a shutter device comprising a drum that can rotate about its horizontal axis and around which the shutter is wound in its open position, forming a roll consisting of turns formed by successive layers of the shutter attached to one another and from which the shutter can be unwound and pushed towards its closed position; the device also comprises means of supporting the drum with respect to the walls of the opening, pressure means exerting on the roll a thrust force substantially radial with respect to the drum. The device can be used for closing any type of opening, for example in buildings or vehicles.

### PRIOR ART

Devices intended for closing an opening comprising a drum around which the shutter is wound in its open position are known. In such devices, the shutter is wound around the drum in successive turns or layers, thus forming a roll around the drum. The shutter is unwound by making the drum turn about its spindle so that the shutter descends, closing the opening while the lateral edges of the latter are preferably guided in two guide paths or slideways extending parallel to each other. By rotating the drum, a thrust force is exerted on the lateral edges of the shutter in their longitudinal direction.

These devices have several drawbacks. The roll formed by the shutter wound in successive turns around the drum during the opening of the shutter is very bulky and is often very irregular. Moreover, during the closure of the shutter, puckers may be formed in the part of the shutter situated above the top end of the slideways at the drum. This may seriously interfere with the normal functioning of the device. Finally, the surface of the shutter becomes scratched after a certain number of openings and closings of the shutter. This is in particular a disadvantage when the shutter has one or more windows that lose their transparency after a certain length of time.

Patent Application WO 03/106801 describes a shutter device that can be wound around a drum and that aims to remedy these drawbacks. In this device, attachment means disposed along the lateral edges of the shutter make it possible to fix the successive layers or turns of the roll to one another in order to prevent the successive layers of shutter sliding with respect to one another. The device comprises a rotary cylinder exerting a thrust force on the roll at the point where the shutter, not yet wound, comes into contact with the roll and return means for the drum for keeping the roll in contact with the rotary cylinder and enabling the successive turns to be fixed to one another.

Given that the diameter of the roll varies (according to the open or closed state of the shutter), the drum and rotary cylinder are mounted so as to be able to move with respect to each other. In this case, the cylinder is mounted fixedly while the shaft of the drum is mounted in a housing that comprises horizontal slideways in which the drum can move horizontally. The drum cooperates with two springs, one of the ends of which is fixed to the drum. The springs keep the roll in contact with the rotary cylinder.

This device has several drawbacks. The number of parts used to ensure contact between the roll and the rotary cylinder is high. The pressure exerted between the rotary cylinder and the lateral edges of the shutter causes heating giving rise to accelerated wear of these edges and the contact elements. In addition, the length of the slideways on the housing depends on the length of the shutter. The housing must be manufactured to measure according to the dimensions of the shutter, which increases the cost and the manufacturing and assembly time. In addition, fixing the springs to the drum is complicated since these must not interfere with the rotation of the drum. Finally, when the shutter is unwound and is interfered with in its descent (rubbing at the slideways or obstacles on the travel of the shutter), the drum is pushed out of contact with the rotary cylinder and the turns become detached from the roll.

Another motorised shutter device is described in the document DE 23 40 642, in which the distance from the rotation spindle of the drum to the vertical wall 1 is continuously greater than or equal to the distance from the suspension spindle to the wall 1. This arrangement is disadvantageous, as will be seen below, in the case of strong winds, because of the risk of detachment of the turns.

### SUMMARY OF THE INVENTION

One aim of the invention is to remedy these drawbacks by presenting a flexible-shutter device that opens and closes in a controlled manner, guaranteeing that a very even roll is obtained during the opening of the flexible shutter and that the latter unrolls without the turns of the roll becoming detached from the roll in an unwanted manner. More particularly, the invention aims to propose a simple device, of reduced cost, easy to manufacture and assemble, wearing little and preventing the locking of the mechanism when the flexible shutter is unwound.

For this purpose, the device according to the invention is characterised in that the means of supporting the drum comprise means of suspending the drum, the suspension means forming a suspension spindle parallel to the rotation spindle of the drum and about which the rotation spindle of the drum can oscillate; the distance from the rotation spindle of the drum to the reference plane formed by the flexible shutter unwound in its closed position is, whatever the position of the shutter, less than the distance from the suspension spindle to this same reference plane.

This method of fixing the drum enables the latter to turn freely about its rotation spindle. The rotation spindle can oscillate about a suspension spindle, so as to enable the drum to move according to the variation in radius of the roll. The angle of oscillation of the rotation spindle of the drum about the suspension spindle with respect to the vertical increases simply with the diameter of the roll.

At the same time, this fixing mode ensures that the roll formed by the turns wound around the drum can remain held in contact against the contact elements when the flexible shutter is closed. This is because, when the flexible shutter is closed, the roll driven in rotation by the motor exerts a thrust force on the lateral edges of the flexible shutter, parallel to these lateral edges and in the direction of travel of the flexible shutter along the opening. In reaction, the lateral edges of the flexible shutter exert on the roll a resultant force parallel and opposite to the thrust force due in particular to the friction exerted between the slideways and the lateral edges of the flexible shutter. This resultant force can cause the separation of the drum and the detachment of the turns with respect to one another; the roll is no longer in contact with the contact elements. Slack turns are then created around the roll, which causes the locking of the device.

In the case of the device according to the invention, where the distance from the rotation spindle of the drum to the vertical reference plane is continuously less than the distance from the suspension spindle to the vertical reference plane, when the flexible shutter is closed, the resulting reaction force generates, because of the offset between the suspension spindle and the rotation spindle of the drum, a moment that brings the roll against the contact elements.

It should be noted that the technical effect due to the offset between the rotation spindle of the drum and the suspension spindle with respect to the reference plane applies for shutters closing both vertical openings and horizontal openings (and all openings in an intermediate position). When the flexible shutter closes a horizontal opening, and provided that the drum is disposed above the opening, the force of gravity also applies, when the distance from the rotation spindle of the drum to the vertical reference plane is continuously less than the distance from the suspension spindle to the vertical reference plane; in this case, the effect of the weight of the drum and roll is added to the effect of the resultant thrust force.

The device for holding the drum and roll is thus particularly simple and effective, not requiring many parts that have to be manufactured specifically according to dimensions of the flexible shutter. At the same time it prevents risks of detachment of the turns when the flexible shutter is closed; the roll is easily kept in contact with the contact elements and keeps the turns continuously adjacent to one another.

The suspension spindle consists either of a single piece or is formed from at least two spindles disposed horizontally at each end of the drum. The straight lines passing through these two spindles are merged.

According to a particular embodiment, the suspension means comprise at least one substantially flat suspension plate, disposed substantially perpendicular to the rotation spindle of the drum at one of the ends thereof, the plate comprising a first opening in which the rotation spindle of the drum is housed and a second opening in which the suspension spindle is housed.

The lateral edges of the flexible shutter are substantially non-compressible in the longitudinal direction of the shutter, namely in the direction of movement of the lateral edges in the slideways. For example, the lateral edges can comprise metal cables or wires. By using a flexible shutter having substantially non-compressible lateral edges, an effective transfer of the resultant force exerted by the lateral edges on the roll (and also of the force exerted on the lateral edges by the rotation of the drum) is ensured.

The flexible shutter device of the invention is particularly advantageous for large shutters and/or ones that are subjected to bad weather and high winds. It prevents the locking of the mechanism when the shutter is unwound. By way of example, the device must be able to function for shutters having a surface area of up to 60 m² which may be subjected to winds ranging up to 160 km/h.

For this purpose, the distance from the rotation axis of the drum to the reference plane formed by the flexible shutter unwound in its closed position is, whatever the position of the shutter, less than the distance from the suspension spindle to this same reference plane.

A wind blowing on the flexible shutter makes it difficult to unwind the latter. The larger the dimensions of the shutter, the greater the effect of the wind on it. The friction forces of the lateral edges on the slideways increase with the effect of the wind. The greater the friction forces on the lateral edges of the flexible shutter, the higher the resultant force that the lateral edges of the shutter exert on the roll and the greater the risk of detachment of the turns with respect to one another.

By thus offsetting the suspension and rotation spindles of the drum in this way, the moment that brings the roll against the contact elements, generated by the friction forces, is all the higher, the greater the friction forces. The drawback created by the friction force at the lateral edges of the flexible shutter, which in the other devices have a tendency to lock the system when the shutter is unwound, is then turned to advantage.

The invention also aims to propose a device in which the flexible shutter, when wound around the drum, forms superimposed layers of very regular and uniform turns.

To this end, the device according to the invention is preferably characterised in that it comprises return means exerting a return torque on the suspension means with respect to the suspension spindle, so as to guarantee continuous contact between the roll and the contact elements.

The return means thus participate in the holding of the roll against the contact elements, when the shutter is wound around the drum. In particular, the return means are necessary for the vertical-shutter devices where the distance from the rotation spindle of the drum to the reference plane is less than the distance from the suspension spindle to this same reference plane. The weight of the roll tends to separate the roll from the contact point.

In this way, a very compact roll is obtained where the successive turns are kept clamped against one another. The device is simple and effective. The return means do not have any direct contact with the drum and the device functions for all lengths of shutter.

According to a first embodiment, the return means comprises a helical spring, one of the ends of the spring being fixed, and a connection means for connecting the other end of the spring to the suspension means. This device is particularly simple to produce. The stiffness of the spring depends on the weight of the shutter. Advantageously, the length of the spring at rest is sufficiently long to reduce the difference to approximately 10% between the length of the spring when the flexible shutter is in the open position and one when the flexible shutter is closed. By reducing this stiffness, the variation in the return force exerted by the spring on the drum is reduced; in this way a relatively constant return force is obtained.

According to a second embodiment, the return means comprises at least one weight fixed to the suspension means so as to exert a return torque on the suspension means with respect to the suspension spindle.

Advantageously, the flexible shutter comprises attachment means extending along the length of the shutter on at least one of the faces of the latter, which fix the successive turns to one another, the contact elements exerting on the attachment means a thrust force that is substantially radial with respect to the drum in order to fix the successive turns of the roll to one another.

In this way, the turns are fixed to one another when the flexible shutter is wound. Slipping of the successive turns on one another is prevented. The attachment means can for example consist of Velcro strips, strips with cooperating projections and cavities, strips with hooks, etc.

According to a particular embodiment of the invention, the contact element comprises a rotary cylinder, the axis of which is substantially parallel to the rotation spindle of the drum.

### BRIEF DESCRIPTION OF THE FIGURES

These aspects as well as other aspects of the invention will be clarified in the detailed description of particular embodiments of the invention, reference being made to the drawings in the figures, in which:

FIG. 1 shows a schematic front view of a flexible shutter device in the position where the opening is closed;

FIG. 2 shows a lateral section of a flexible shutter device in the position where the opening is open, according to the prior art;

FIG. 3 shows a side view of the device of FIG. 2 in the intermediate position.

FIG. 4 shows a lateral section of the device of FIG. 2 in the position of closing the opening.

FIG. 5 shows a lateral view of the flexible shutter device of FIG. 2 in an intermediate position when a detachment of the turns with respect to one another occurs during the unwinding of the flexible shutter;

FIG. 6 shows a side view of a flexible shutter device in the open position of the opening according to the invention;

FIG. 7 shows a side view of the flexible shutter device of FIG. 6 in the intermediate position;

FIG. 8 shows a side view of the flexible shutter device of FIG. 6 in the closed position of the opening;

FIG. 9 shows a side view of a flexible shutter device in the closed position of the opening according to a particular embodiment of the invention;

FIG. 10 shows a detailed side view of the flexible shutter device of FIG. 9 in the closed position of the opening;

FIG. 11 shows a side view of the device of FIG. 10, the flexible shutter being wound towards the open position;

FIG. 12 shows a side view of a flexible shutter device in the closed position of the opening according to another particular embodiment of the invention;

FIG. 13 shows a side view of the device of FIG. 12 in the open position of the opening.

FIGS. 14 and 15 show a side view of a variant embodiment respectively in the open and closed position.

FIGS. 16 and 17 show a detail view of the top of the slideway of the device illustrated in FIGS. 14 and 15.

The figures are not drawn to scale. Generally, similar elements are denoted by similar references in the figures.

### DETAILED DESCRIPTION OF PARTICULAR EMBODIMENTS

It will be obvious to a person skilled in the art that the present invention is not limited to what was disclosed and described in particular above. The invention lies in the presentation of all novel features and each combination of these features. The numerical references in the claims do not limit the scope of their protection. The use of the words “comprise, have or include” and their conjugate forms does not exclude the presence of elements other than those enumerated in the claims. The use of the article “a/an” in front of an element does not exclude the presence of a plurality of such elements.

In general terms, the present invention relates to a flexible shutter device cooperating with driving means, such as a drum, the spindle of which is connected to the shaft of an electric motor. The flexible shutter moves between a closed position and an open position and is intended in particular for closing an opening in a door or passage, such as a corridor.

The term “flexible shutter” should be understood, in the context of the present invention, to mean any flexible flat element such as a canvas, articulated slats, metal sheet, etc., which is provided at its lateral ends with substantially non-compressible edges. It is also a case of a shutter that can be wound around a drum, the axis of which is perpendicular to the direction of movement of the shutter when the latter is opened.

It should however be noted that a pronounced preference is given to flexible shutters formed for example by a canvas. The accompanying figures consequently relate more particularly to such a canvas.

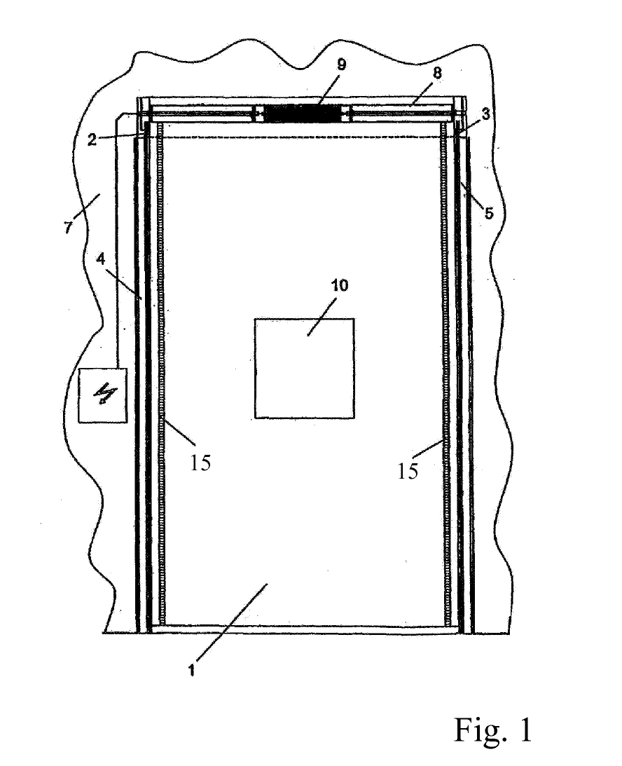

In FIG. 1, the flexible shutter device is shown schematically in the closed position. This device comprises a flexible shutter 1 with lateral edges 2 and 3 projecting with respect to the plane of the shutter 1 that are advantageously formed by a continuous bead moving in slideways 4 and 5. The slideways 4 and 5 are provided on each side of an opening 6 that is present in a wall 7.

Each of the slideways 4, 5 has a U-shaped cross-section, the central part 40 of which is up against the structure of the opening 6, the opening of the U of a slideway 4 being directed towards the opening of the other slideway 5.

Each U-shaped slideway 4, 5 comprises an arm 42 that extends at the rear, towards the wall 7, and another arm 44 that extends at the front, towards the drum 8.

Above the opening 6 a drum 8 is provided on which the flexible shutter 1 can be wound. Inside the drum 8 there is arranged an electric motor 9 that drives the drum 8 about its spindle 11. Alternatively the electric motor 9 can be disposed outside the drum 8. The shutter 1 is wound on the drum 8 in order to bring it into the open position or unwound towards its closed position. When the shutter 1 is opened, it is wound around the drum 8 forming a roll consisting of turns formed by successive superimposed layers of the shutter 1. When the shutter 1 moves towards the closed position, the lateral edges 2 and 3 thereof are guided by the slideways 4 and 5.

In the middle of the flexible shutter 1 a transparent window 10 is provided.

Preferably, attachment means 15 extend along the length of the shutter 1 on one or each of the faces of the latter. When the shutter 1 is wound or unwound around the drum, the attachment means fix the successive turns of the flexible shutter to one another in order to prevent the successive layers of the shutter 1 sliding with respect to one another.

Means of supporting the drum 8 are provided which comprise means of suspending the drum forming a suspension spindle 13 parallel to the rotation spindle 11 of the drum and about which the rotation spindle of the drum can oscillate. The distance from the rotation spindle 11 of the drum to the reference plane formed by the flexible shutter 1 unwound in its closed position is, whatever the position of the shutter, greater than the distance from the suspension spindle 13 to this same reference plane.

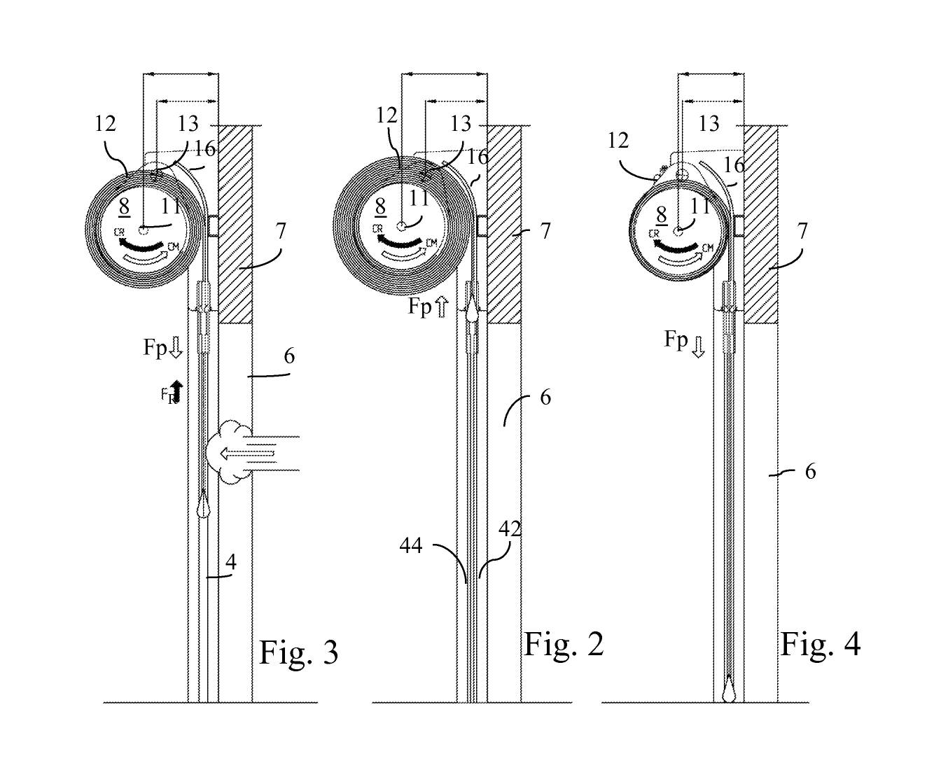

FIGS. 2, 3, 4 show a side view of the flexible shutter device according to FIG. 1 in an arrangement according to the prior art, where the distance from the rotation spindle 11 of the drum 8 to the reference plane is continuously greater than the distance from the suspension spindle 13 to the reference plane.

The suspension means comprise, at each end of the drum 8, a cheek 12 held on a fixing frame 14, itself mounted above the opening 6 so as to be fixed on the wall 7. Each cheek 12 comprises a first opening in which the rotation spindle 11 of the drum can be housed. The rotation spindle of the drum 8 can turn freely in this opening. Each cheek 12 comprises a second opening disposed above the rotation spindle 11. The second opening holds the cheek 12 on the fixing frame 14. The cheeks 12 can pivot freely about a suspension spindle 13. The cheeks 12 thus make it possible to suspend the drum 8.

The drum 8 can turn freely about its rotation spindle 11. The rotation spindle 11 of the drum 8 can oscillate about the suspension spindle 13 disposed above the drum 8 so as to enable the drum to move according to the variation in the radius of the roll. The angle of oscillation of the rotation spindle 11 of the drum about the suspension spindle 13 with respect to the vertical increases simply with the diameter of the roll.

A contact element 16 is provided that makes it possible to exert a thrust force at the point where the flexible shutter 1 winds (or unwinds) on the roll formed by the turns of the shutter wound on the drum 8. The pressure element 16 holds the turns adjacent to one another.

When the shutter 1 is closed, the roll driven in rotation by the motor exerts a thrust force F_{P} on the lateral edges 2, 3 of the shutter, parallel to these lateral edges and in the direction of travel of the shutter along the opening. In reaction, the lateral edges 2, 3 of the flexible shutter exert on the roll a resultant force F_{R} parallel and opposite to the thrust force due in particular to the friction exerted between the slideways 4, 5 and the lateral edges 2, 3 of the shutter. The distance from the rotation spindle 11 of the drum to the reference plane being continuously greater than the distance from the suspension spindle 13 to the reference plane, this resultant force generates a moment C_{R} at the roll that may cause the separation of the drum 8 with respect to the contact element 16.

However, because of the relative arrangement of the suspension 13 and rotation 11 spindles with respect to the reference plane, the weight of the drum 8 and of the roll generates a moment C_{M} that returns the drum 8 against the contact element 16. The weight of the drum and of the roll counteracts the effect of the resultant force F_{R} and ensures that the roll remains in contact against the contact element 16, preventing the separation of the roll.

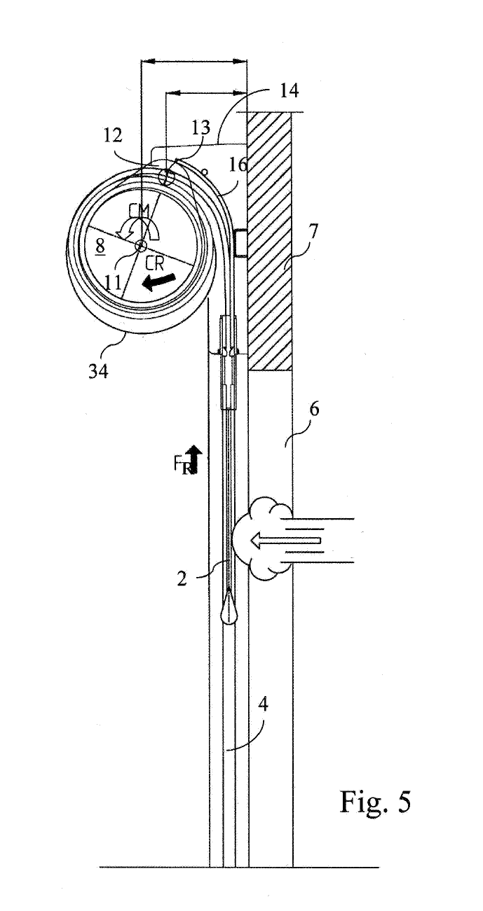

FIG. 5 shows the flexible shutter device according to the prior art, in which the shutter 1, which is unwound for the purpose of closing the opening 6, is subjected to strong winds.

A wind blowing on the shutter 1 makes it difficult to unwind the latter. This is because the friction forces F_{R} of the lateral edges 2, 3 on the slideways 4, 5 increase with the effect of the wind. The higher the friction forces on the lateral edges of the flexible shutter, the higher the resulting moment C_{R} exerted on the drum 8. When the winds reach a certain speed, the moment C_{M} due to the weight of the drum 8 and roll is no longer sufficient to oppose the resultant moment C_{R}. The drum 8 then separates from the contact element 16. The drum 8 despite everything continues to be driven in rotation, which causes the detachment of the turns 34 with respect to one another around the roll and possibly the locking of the device.

Naturally the friction forces may be due to the wind in the shutter, but also to any other reason (obstacle on the travel of the shutter during its unwinding, etc.).

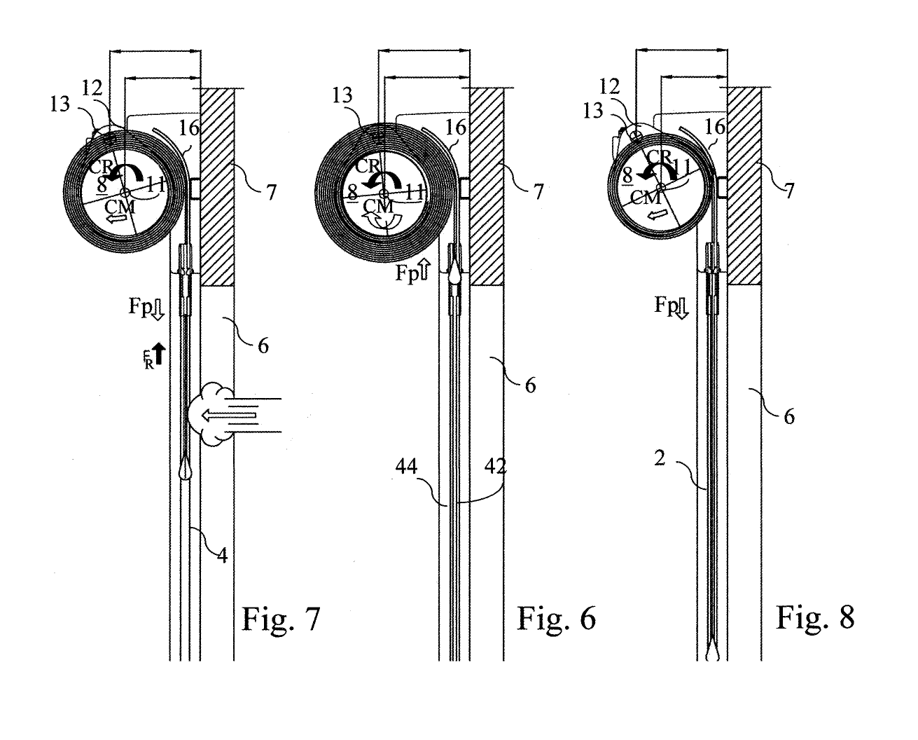

FIGS. 6 to 8 show a flexible shutter device according to the invention.

Because of the relative arrangement of the suspension 13 and rotation 11 spindles with respect to the reference plane, the friction forces F_{R} that appear at the lateral edges 2, 3 in the slideways 4, 5 generate a moment C_{R} that returns the drum 8 against the contact element 6. The higher the friction forces, the greater the moment C_{R}. The friction forces F_{R} thus participate in the holding of the roll against the contact elements 16. The roll does not separate from the contact element 16. The separation of the drum 8 is thus prevented even in the case of interference or obstacle for the flexible shutter 1 during its unwinding.

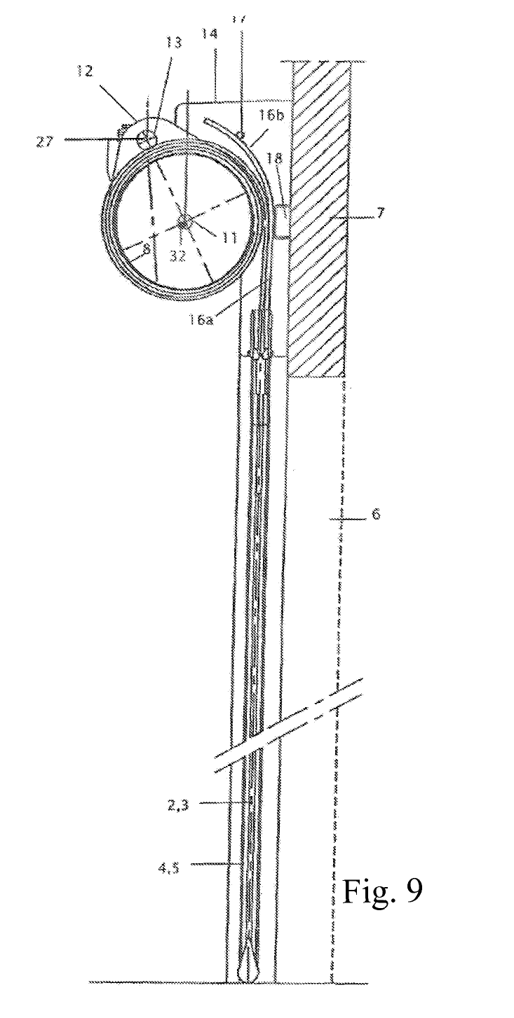

FIGS. 9 to 11 show certain supplementary details of the device according to the invention.

The cheeks 12 are preferably formed by a substantially flat plate with an ovoid cross-section. The rotation spindle 11 of the drum can for example be held against the cheeks 12 in free rotation by a ball-bearing mechanism. Joining pieces 32 hold the rotation spindle 11 of the drum 8 on the cheeks 12 so as to prevent it being detached from the cheeks 12.

In the embodiment illustrated in FIGS. 9 to 11, the contact element comprises a contact plate 16 having a first substantially flat first part 16a and a curved second part 16b. The first part 16a of the contact plate 16 is held by means of an abutment support 18 fixed to the wall 7 in line with the slideways 4, 5. The flat part 16a of the contact plate 16 constitutes a guide plate for the lateral edges 2, 3 of the shutter 1 from their exit from the slideways 4, 5 until the moment when they wind on the roll. By gripping the lateral edges 2, 3 of the flexible shutter 1 between the roll and the contact plate 16 at the moment when the shutter 1 winds on the roll, the formation of very regular and uniform superimposed layers of turns is ensured. In the case of a shutter comprising attachment means, the pressure element exerts pressure on these attachment means in order to fix the successive turns of the shutter on each other when the latter is wound around the drum 8.

The second curved part 16b of the contact plate is disposed above the drum 8 so as to surround at least part of the roll. The curved part 16b of the contact plate 16 thus constitutes a means of confining the turns around the roll. The radius of curvature of the second curved part 16b is preferably equal to or slightly greater than the radius of the roll when the flexible shutter 1 is in the open position. The curved part 16b of the contact plate 16 is thus adjacent to the roll, when the shutter 1 is in the open position. The confinement means 16b then ensures the holding of the external turn of the roll for the shutter in the open position.

According to another embodiment, not shown, the radius of curvature of the second curved part 16b is preferably equal to or slightly greater than the radius of the roll when the flexible shutter 1 is in the closed position. The curved part 16b of the contact plate 16 is produced from a flexible material (polyethylene for example) so that the curved part 16b of the contact plate 16 deforms when the shutter 1 is wound while remaining continuously in contact with the roll. Likewise, on unwinding, the curved part 16b of the contact plate 16 returns to its initial position.

Alternatively, the first and second parts of the contact plate 16 constitute two distinct pieces.

In the example illustrated in FIG. 9, the plate 16 is in abutment against a stop lug 17 fixed to the frame 14.

In another embodiment, not shown, the contact element comprises a rotary cylinder, the axis of which is substantially parallel to the rotation axis of the drum 18. The cylinder is provided at the point where, during the winding and unwinding of the flexible shutter 1, the shutter winds up or unwinds.

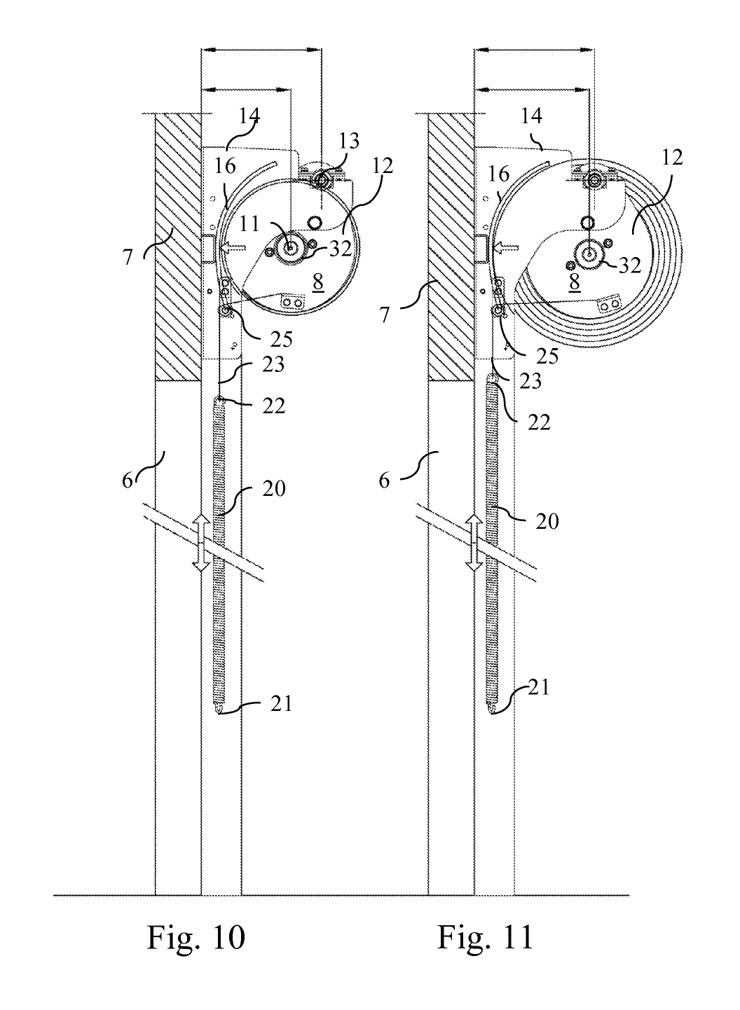

FIGS. 10 and 11 show a means helping to keep the roll in contact with the contact elements, according to a particular embodiment of the invention.

The device comprises a return means for keeping the roll in contact with the contact elements. A return means is disposed at the two ends of the drum. The return means comprises a helical spring 20 disposed vertically along the wall 7. A first end 21 of the spring 20 is held fixedly on the wall 7 of the opening 6. The other end 22 of the spring 20 is attached to a rope 23 fixed to the cheek 12 close to the rim of the cheek 12. The rope 23 passes over a pulley 25 fixed to the fixing frame 14, in particular for guiding the rope 23 and preventing its interfering with the functioning of the other parts. The coefficient of stiffness of the helical spring 20 depends on the weight of the shutter 1, namely its dimensions. The length of the spring 20 is sufficiently long so that its length varies little whether the flexible shutter is in the open position or closed position. The return force of the spring, applied to the cheeks 12, thus remains relatively constant whatever the position of the shutter.

The return means thus advantageously participate in the holding of the roll against the contact elements 16.

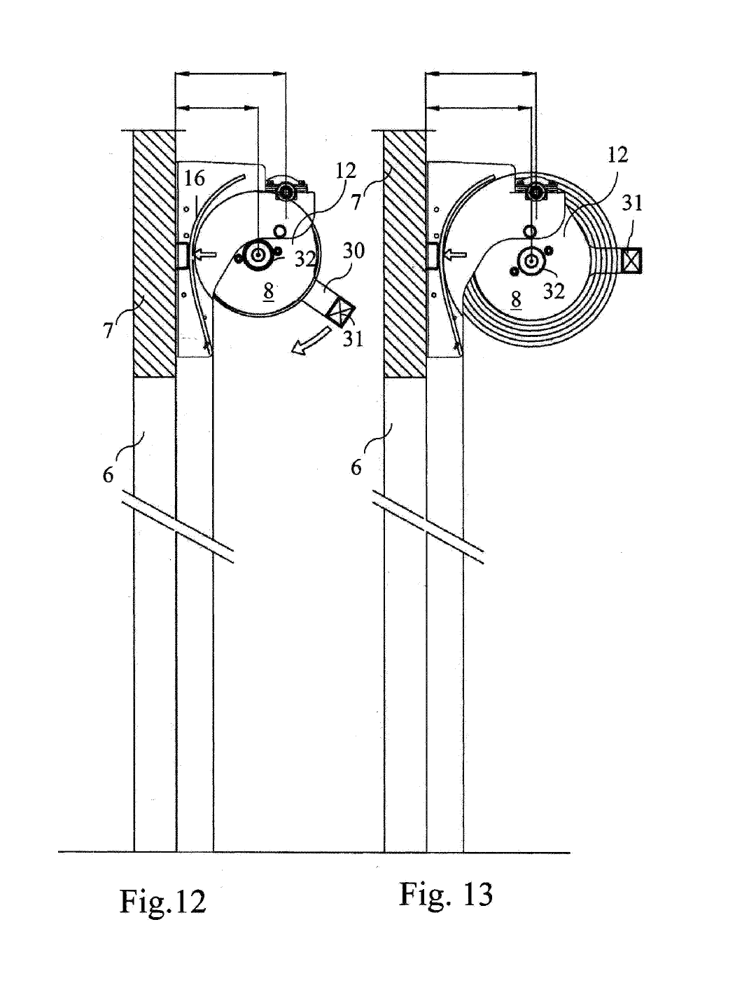

FIGS. 12 and 13 show a return means for keeping the roll in contact with the contact elements, according to another embodiment of the invention.

The plate 12 comprises a lever arm 30 disposed tangentially to the edge of the former. At the free end of the lever arm a weight 31 is fixed. The length of the lever arm 30 may vary. The magnitude of the weight 31 is chosen according to the dimensions of the flexible shutter 1.

The present invention has been described in terms of specific embodiments that are an illustration of the invention and must not be considered to be limitative.

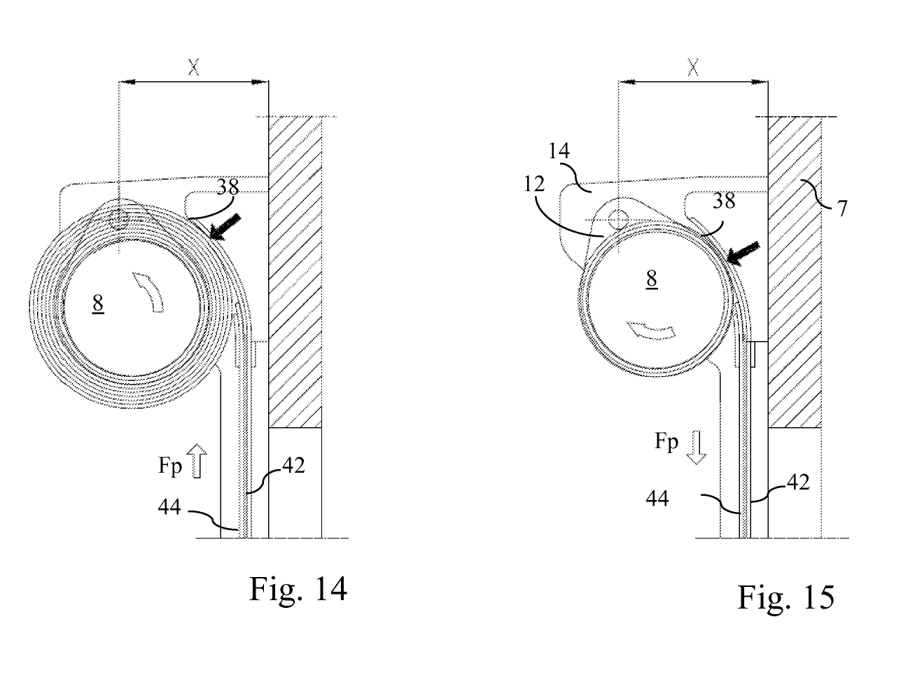

FIGS. 14 to 17 show another variant embodiment. In this case, the contact element between the roll and the wall 7 is no longer a flexible plate but consists of a rigid block 36.

The surface 38 of the block 36 directed towards the drum 8 has a particularly suited curved shape. In the figures, the contact point (where the friction is maximum) between the surface 38 and the shutter 1 at the winding or unwinding point is illustrated by an arrow.

In this embodiment, the front arms 44 of the slideways 4 and 5 extend to a height such that the distance between the top end of the arms 44 and the last turn wound on the drum 8 is very small, around 5 to 10 mm.

On the other hand, the rear arms 42 of the slideways 4 and 5 extend upwards higher than the front arms 44, by a curved part that comes to bear on and follow the shape of the surface 38 of the block 36.

It has been discovered that, with this particular embodiment, the contact point is not fixed but moves progressively during winding or unwinding of the flexible shutter 1. This is because, in the open position (FIG. 14, roll bulky), the contact point is situated higher on the surface 38 than in the closed position (FIG. 15, roll compact).

The fact that the contact point moves is very advantageous since the friction and therefore wear will be distributed over part of the surface 38 of the block 36 and will not be concentrated at a single point.

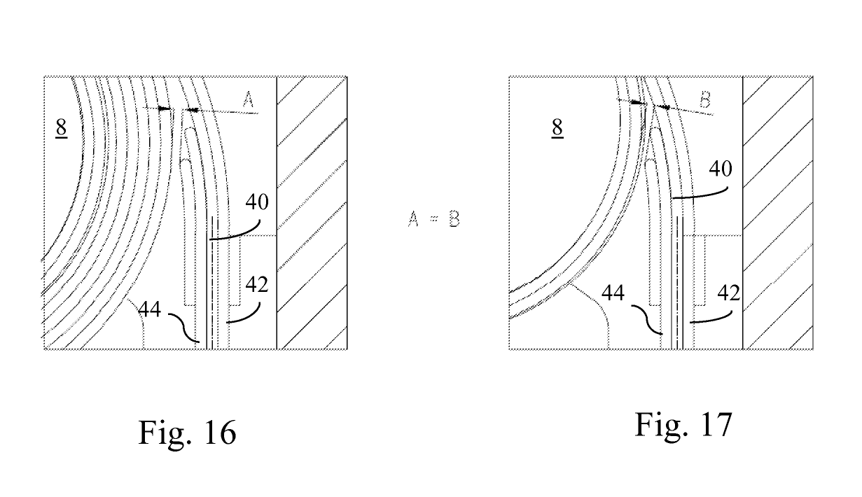

Another advantage of this variant embodiment is that the space (A, B) illustrated in FIGS. 16 and 17, between the top part of the front arm 44 of the slideways 4 and 5 and the last turn wound, remains small, whatever the position of the flexible shutter device. In the closed position, when the roll is compact, the space B is as small as the space A, in the open position when the roll is bulky.

The spaces A and B are sufficiently small to prevent the buckling effect that would cause a fold in the lateral edges (2, 3). This is mainly important when the roll is unwound, when the flexible shutter device is closed. Buckling can thus be prevented without adding another means of holding or guiding the shutter.

1. Flexible shutter device intended for closing a window or door opening or any type of opening, cooperating with driving means for moving the flexible shutter between an open position and a closed position, the device comprising:
a drum that can rotate about its horizontal spindle and around which the shutter is wound in its open position, forming a roll consisting of turns formed by successive layers of shutter attached to one another and from which the shutter can be unwound and pushed towards its closed position,
means of supporting the drum with respect to the walls of the opening,
at least one contact element exerting on the roll a thrust force that is substantially radial with respect to the drum,
the means of supporting the drum comprising means of suspending the drum and these suspension means comprising a suspension spindle parallel to the rotation spindle of the drum and about which the drum can oscillate,
the flexible shutter having lateral edges substantially non-compressible in the longitudinal direction of the shutter,
characterised in that
the distance from the rotation spindle of the drum to the reference plane formed by the flexible shutter in its closed position is, whatever the position of the shutter, less than the distance from the suspension spindle to the vertical reference plane.

2. Device according to claim 1, characterised in that the suspension means comprise at least one substantially flat suspension plate, disposed substantially perpendicular to the rotation spindle of the drum at one of the ends thereof, the plate comprising a first opening in which the rotating spindle of the drum is housed and a second opening in which the suspension spindle is housed.

3. Device according to claim 1, comprising return means exerting a return torque on the suspension means with respect to the suspension spindle, so as to guarantee continuous contact between the roll and the contact elements.

4. Device according to claim 3, characterised in that the return means comprise a helical spring.

5. Device according to claim 4, characterised in that one of the ends of the helical spring is fixed and a connection means connects the other end of the helical spring to the suspension means.

6. Device according to claim 3, characterised in that the return means comprise at least one weight fixed to the suspension means.

7. Device according to claim 1, characterised in that the contact element comprises a flexible plate having a substantially flat part and a curved second part.

8. Device according to claim 1, characterised in that the contact element comprises a rigid support whose surface turned towards the drum is curved.

9. Device according to claim 8, characterised in that the curvature of the surface of the support is such that the contact point between this surface and the roll consisting of turns moves during the winding and unwinding of the flexible shutter.

10. Device according to claim 8, characterised in that it comprises U-shaped runners, in which the lateral edges of the flexible shutter are able to slide, the rear arm of the U being extended upwards by a curved part able to follow the surface of the rigid support.

11. Device according to claim 9, characterised in that it comprises U-shaped runners, in which the lateral edges of the flexible shutter are able to slide, the rear arm of the U being extended upwards by a curved part able to follow the surface of the rigid support.

12. Device according to claim 5, characterised in that the return means comprise at least one weight fixed to the suspension means.
